(19) United States
(12) Patent Application Publication
(10) Pub. No.: US 2015/0079496 A1
(43) Pub. Date: Mar. 19, 2015

(54) CATHODE MATERIAL AND SOLID OXIDE FUEL CELL

(71) Applicant: NGK INSULATORS, LTD., Nagoya-shi (JP)

(72) Inventors: Makoto OHMORI, Nagoya-shi (JP); Ayano KOBAYASHI, Nagoya-shi (JP)

(21) Appl. No.: 14/464,830

(22) Filed: Aug. 21, 2014

Related U.S. Application Data
(60) Provisional application No. 61/975,947, filed on Apr. 7, 2014.

(30) Foreign Application Priority Data
Aug. 23, 2013 (JP) 2013-173401
Aug. 13, 2014 (JP) 2014-164700

(51) Int. Cl. H01M 4/90; C01G 51/00

(52) U.S. Cl. CPC H01M 4/9033; C01G 51/70; H01M 2008/1293
USPC 429/489; 423/263

(57) ABSTRACT

A cathode material contains a main component being a complex oxide having a perovskite structure expressed by a general formula ABO₃. The perovskite structure includes at least one of La and Sr at the A site. A occupied surface area ratio of a plurality of comparable crystal orientation domains is at least 10%. The plurality of comparable crystal orientation domains is defined by boundaries exhibiting a crystal orientation difference of at least 5 degrees in a crystal orientation analysis of a cross section by a method of electron backscatter diffraction.

### CROSS-REFERENCE TO RELATED APPLICATIONS

This application claims priority to Japanese Patent Application No. 2013-173401 filed on Aug. 23, 2013, Japanese Patent Application No. 2014-164700 filed on Aug. 13, 2014 and U.S. provisional patent application 61/975,947 filed on Apr. 7, 2014. The entire disclosure of Japanese Patent Application No. 2013-173401, Japanese Patent Application No. 2014-164700 and U.S. provisional patent application 61/975,947 is hereby incorporated herein by reference.

### BACKGROUND

1. Technical Field

The present invention relates to a cathode material and to a solid-oxide fuel cell provided with a cathode.

2. Description of the Related Art

A solid oxide fuel cell generally includes an anode, a solid electrolyte layer, and a cathode. The cathode material includes use of a complex oxide having a perovskite structure such as (La, Sr)(Co, Fe)O₃, or the like. (For example, reference is made to Japanese Patent Application Laid-Open No. 2006-32132).

### SUMMARY

In this regard, it is preferable to increase the activity of the cathode in order to enhance the output of the solid oxide fuel cell.

The present inventors performed diligent investigation and gained the new insight that the occupied surface area ratio of regions having a comparable crystal orientation to the total solid phase of the cathode or the cathode material is related to the activity of the cathode.

The present invention is proposed in light of the above circumstances and has the purpose of providing a cathode material that enhances the output of a solid oxide fuel cell, and providing a solid oxide fuel cell that is configured to enhance its output.

### Solution to Problem

A cathode material according to the present invention has a main component being a complex oxide having a perovskite structure expressed by a general formula ABO₃. The perovskite structure includes at least one of La and Sr at the A site. A occupied surface area ratio of a plurality of comparable crystal orientation domains to a total solid phase is at least 10%. The plurality of comparable crystal orientation domains is defined by boundaries exhibiting a crystal orientation difference of at least 5 degrees in a crystal orientation analysis of a cross section by a method of electron backscatter diffraction.

### Advantageous Effects of Invention

The present invention provides a cathode material that enhances the output of the solid oxide fuel cell, and a solid oxide fuel cell that is configured to enhance its output.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Referring now to the attached drawings which form a part of this original disclosure:

FIG. 1 is a cross sectional view illustrating the configuration of a solid oxide fuel cell.

FIG. 2 illustrates an example of a SEM image of a cathode material.

FIG. 3 illustrates an example of an EBSD image of the cathode material.

FIG. 4 illustrates an example of a SEM image of a cathode material.

FIG. 5 illustrates an example of an EBSD image of the cathode.

### DETAILED DESCRIPTION OF THE PREFERRED EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

Next, the embodiments of the present invention will be described making reference to the figures. In the description of the figures below, the same or similar portions are denoted by the same or similar reference numerals. However, the figures are merely illustrative and the ratio of respective dimensions or the like may differ from the actual dimensions. Therefore, the actual dimensions or the like should be determined by reference to the following description. Furthermore, it goes without saying that the ratios or the relations of dimensions used in respective figures may be different.

### Configuration of Solid Oxide Fuel Cell 10

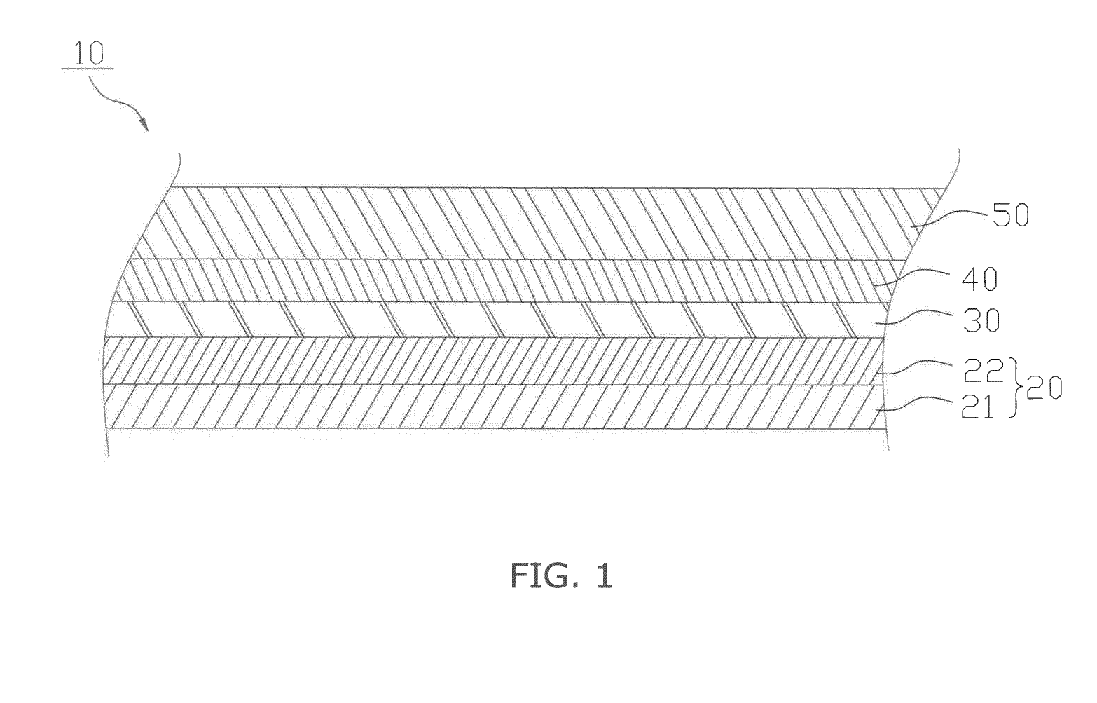

The configuration of the solid oxide fuel cell (SOFC) 10 will be described making reference to the figures. FIG. 1 is a cross sectional view of the configuration of the solid oxide fuel cell 10.

The solid oxide fuel cell 10 is a fuel cell that may have a vertically striped configuration, a horizontally striped configuration, an anode-support configuration, an electrolyte tabular configuration, or a cylindrical configuration. The solid oxide fuel cell 10 as illustrated in FIG. 1 includes an anode 20, a solid electrolyte layer 30, a barrier layer 40 and a cathode 50.

The anode 20 has the function of an anode of the solid oxide fuel cell 10. The anode 20 as illustrated in FIG. 1 is configured from an anode current collecting layer 21 and an anode active layer 22.

The anode current collecting layer 21 may be configured from a main component being Ni and an oxygen ion conductive material. The anode current collecting layer 21 for example may include Ni in the form of NiO. When the anode current collecting layer 21 contains NiO, the NiO may be reduced to Ni by the action of hydrogen gas during electrical energy production. The oxygen ion conductive material includes yttria-stabilized zirconia (3YSZ, 8YSZ, 10YSZ, or the like), or scandia-stabilized zirconia (ScSZ), or the like. The volume ratio of Ni and/or NiO in the anode current collecting layer 21 may be 35 to 65 volume % using an Ni conversion, and the volume ratio of the oxygen ion conductive material may be 35 to 65 volume %. The anode current collecting layer 21 is a porous material and preferably the porosity of the anode current collecting layer 21 during reduction processes is at least 15% to no more than 50%. The thickness of the anode current collecting layer 21 is at least 0.2 mm to no more than 5.0 mm.

In the present embodiment, the feature of “composition A includes material B as a main component” means that preferably the content of material B in composition A is at least 60 wt %, and more preferably that the content of material B in composition A is at least 70 wt %.

The anode active layer 22 is disposed between the anode current collecting layer 21 and the solid electrolyte layer 30. The anode active layer 22 has a main component of Ni and an oxygen ion conductive material. The anode active layer 22 for example may include Ni in the form of NiO. When the anode active layer 22 contains NiO, the NiO may be reduced to Ni by the action of hydrogen gas during electrical energy production. The oxygen ion conductive material includes 3YSZ, 8YSZ, 10YSZ and ScSZ, or the like. The volume ratio of Ni and/or NiO in the anode active layer 22 may be 25 to 50 volume % using an Ni conversion, and the volume ratio of the oxygen ion conductive material may be 50 to 75 volume %. The anode active layer 22 is a porous material and preferably the porosity of the anode active layer 22 during reduction processes is at least 15% to no more than 50%. The thickness of the anode current collecting layer 21 is at least 5.0 micrometers to no more than 30 micrometers.

The solid electrolyte layer 30 is disposed between the anode 20 and the cathode 50. The solid electrolyte layer 30 has the function of enabling transmission of oxygen ions produced by the cathode 50. The material used in the solid electrolyte layer 30 includes for example, 3YSZ, 8YSZ, 10YSZ and ScSZ, or the like. The solid electrolyte layer 30 is configured as a dense material, and preferably the porosity of the solid electrolyte layer 30 is no more than 10%. The thickness of the solid electrolyte layer 30 is at least 3.0 micrometers to no more than 30 micrometers.

The barrier layer 40 is disposed between the solid electrolyte layer 30 and the cathode 50. The barrier layer 40 has the function of suppressing formation of a highly resistive layer between the solid electrolyte layer 30 and the cathode 50. The material used in the barrier layer 40 includes ceria (CeO₂) and a ceria-based material including a rare earth metal oxide in solid solution in CeO₂. The ceria-based material includes gadolinium doped ceria (GDC: (Ce,Gd)O₂), samarium doped ceria (SDC (Ce, Sm)O₂), or the like. The barrier layer 40 is configured as a dense material, and preferably the porosity of the solid barrier layer 40 is no more than 15%. The thickness of the barrier layer 40 is at least 3.0 micrometers to no more than 20 micrometers.

The cathode 50 is disposed on the barrier layer 40. The cathode 50 functions as the cathode of the solid oxide fuel cell 10. The cathode 50 is configured as a porous material, and preferably the porosity of the cathode 50 is no more than 25% to 50%. The thickness of the cathode 50 is at least 3.0 micrometers to no more than 600 micrometers.

The cathode 50 has a main component being a complex oxide having a perovskite structure expressed by the general formula ABO₃. At least one of La and Sr are included at the A site. This type of complex oxide includes lanthanum strontium cobalt ferrite (LSCF), lanthanum strontium ferrite (LSF), lanthanum strontium cobaltite (LSC), lanthanum strontium manganite (LSM), and LSM-8YSZ, or the like.

Therefore, the material for the cathode 50 (referred to below as “cathode material”) is a material that contains a main component being a complex oxide having a perovskite structure expressed by the general formula ABO₃ and including at least one of La and Sr at the A site. The cathode material may be configured as an aggregate of particles, a powder (for example, with an average particle diameter of at least 0.1 micrometer to no more than 5 micrometers), a milled product (for example, with an average particle diameter of at least 5 micrometers to no more than 500 micrometers), or as a mass that is larger than the milled product. This cathode material may be prepared by milling a powder of a starting material of the complex oxide. The method of preparing the cathode material will be described below.

### Analysis of Crystal Orientation of Cathode Material

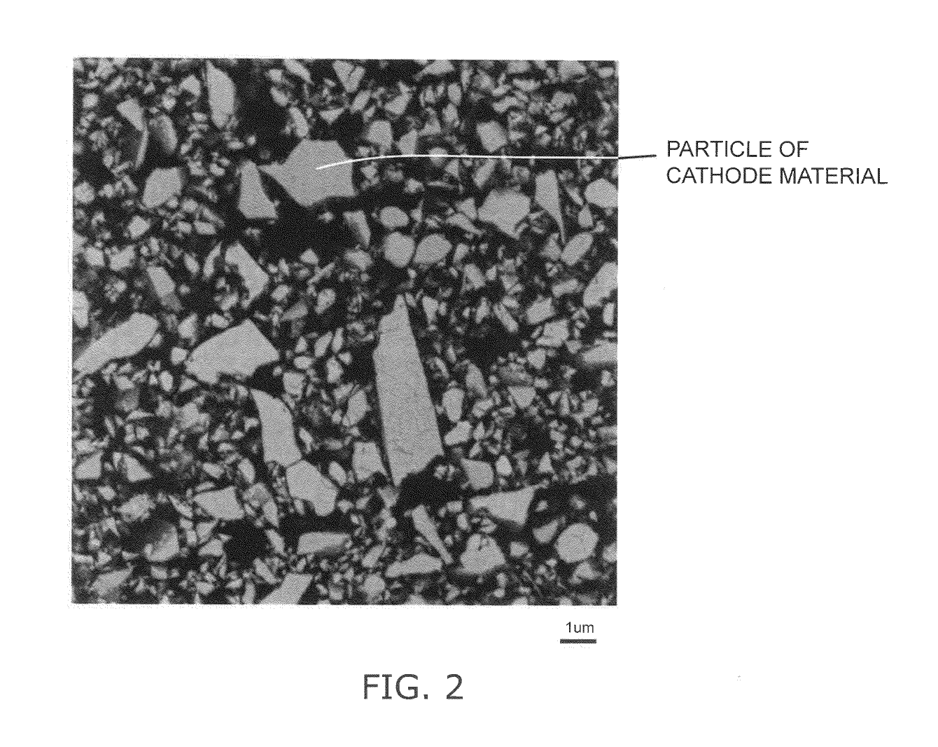

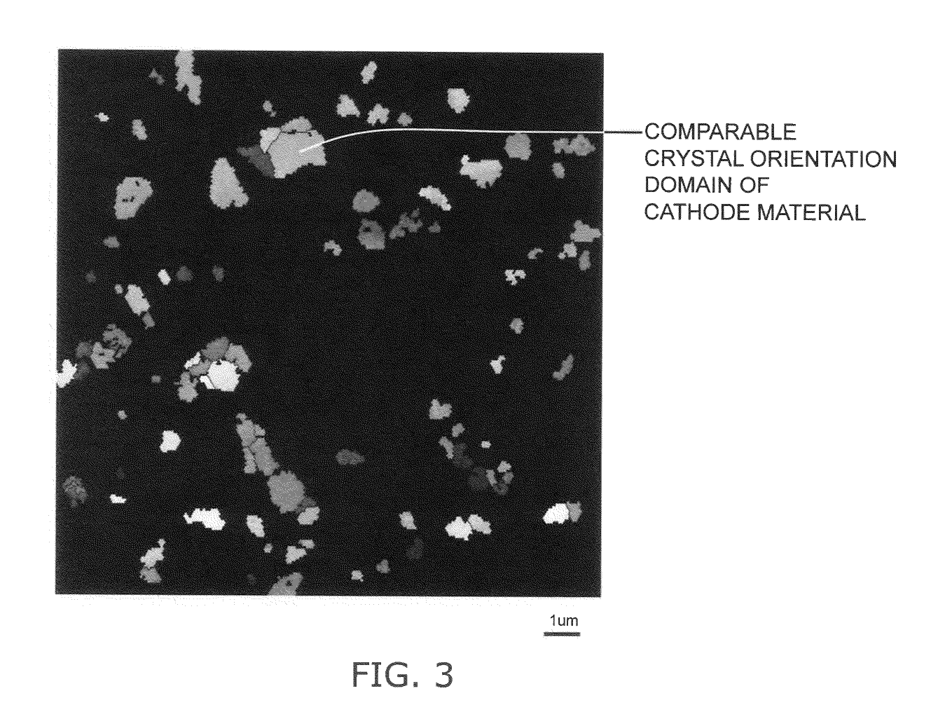

The results of the crystal orientation analysis of the cathode material will be described making reference to the drawings. FIG. 2 illustrates an example of a SEM image of a cross section of cathode material that has been enlarged with a magnification of ×5000 by use of a scanning electron microscope (SEM). FIG. 3 illustrates an example of an EBSD image illustrating the results of analysis of crystal orientation by use of electron backscatter diffraction (EBSD) in relation to the cross section of the cathode material illustrated in FIG. 2. In FIG. 2 and FIG. 3, a cut surface of a block which is produced by the cathode material solidifying with a curable resin (for example an epoxy resin). In the following description, the simple reference to “cross section” means a parallel cross section to the direction of thickness of each layer that configures the solid oxide fuel cell 10.

The analysis of crystal orientation by use of an EBSD method enables observation of non-continuity in the crystal orientation, and enables imaging of regions defined by the boundaries in which the crystal orientation difference is greater than a predetermined angle (referred to below as “comparable crystal orientation domain”). In FIG. 3, the comparable crystal orientation domains are defined by boundaries in which the crystal orientation difference is at least 5 degrees.

As illustrated in FIG. 2, the outer shape of each individual particle is visible by reference to the SEM image of the cathode material. The SEM image can be used to calculate the total surface area of the solid phase in a cross section of the cathode material. In the present embodiment, the term “solid phase of the cathode material” is a general reference to the phase of the cathode material that is in a solid configuration, and denotes the concept of not including gaps (spaces). In FIG. 2, the region corresponding to gaps (spaces) is shown in black, and resin is filled into that region. The range of calculating the total surface area of the solid phase may be the imaging range of the SEM. However, there is no limitation in this regard and, for example, the range may be configured as 10 micrometers×10 micrometers to 50 micrometers×50 micrometers.

As illustrated in FIG. 3, the outer shape of each comparable crystal orientation domain that is defined by boundaries in which the crystal orientation difference is at least 5 degrees is visible by reference to the EBSD image of the cathode material. The EBSD image can be used to calculate the total surface area of the comparable crystal orientation domains in a cross section of the cathode material. The range of calculating the total surface area of the comparable crystal orientation domains may be the same as the range for calculation of the total surface area of the solid phase. The occupied surface area ratio of the total surface area of the comparable crystal orientation domains relative to the solid phase total surface area is at least 10%.

In this context, FIG. 3 does not include illustration of comparable crystal orientation domains in which the equivalent circle diameter is 0.03 micrometers or less. Therefore, in the present embodiment, the surface area of comparable crystal orientation domains in which the equivalent circle diameter is 0.03 micrometers or less is not included in the total surface area of the comparable crystal orientation domains. The exclusion of those comparable crystal orientation domains that are associated with an extremely small equivalent circle diameter is due to that fact that those comparable crystal orientation domains do not participate in the enhancement of the activity of the cathode. In the present embodiment, the term “equivalent circle diameter” denotes the diameter of a circle that has the same surface area as the target object.

Furthermore, FIG. 3 does not include illustration of comparable crystal orientation domains that are included in particles having a particle diameter of 0.3 micrometers or less. Therefore, in the present embodiment, the surface area of the comparable crystal orientation domains that are included in particles having a particle diameter of 0.3 micrometers or less is not included in the total surface area of the comparable crystal orientation domains. The exclusion of those comparable crystal orientation domains that include particles with extremely small particle diameters is due to that fact that those particles do not participate in the enhancement of the activity of the cathode.

As shown by a comparison of FIG. 2 and FIG. 3, the boundaries on the EBSD image does not always correspond with the grain boundaries on the SEM image. That is to say, the comparable crystal orientation domains and the particles denote different concepts. Therefore, it may be the case that there is a plurality of comparable crystal orientation domains in one particle, or a plurality of particles in one comparable crystal orientation domain.

The equivalent circle diameter of the comparable crystal orientation domains may be configured as 0.01 micrometers to 5 micrometers. The average equivalent circle diameter of the comparable crystal orientation domains may be configured as at least 0.03 micrometers to no more than 2.8 micrometers. The average equivalent circle diameter is an arithmetic mean value for the respective equivalent circle diameters of a plurality of comparable crystal orientation domains. The standard deviation of the equivalent circle diameter of the comparable crystal orientation domains may be at least 0.1 and no more than 3.

The standard deviation or the average equivalent circle diameter of the comparable crystal orientation domains in the cathode material may be controlled by adjusting the milling conditions for the starting material powder.

### Analysis of Crystal Orientation of Cathode 50

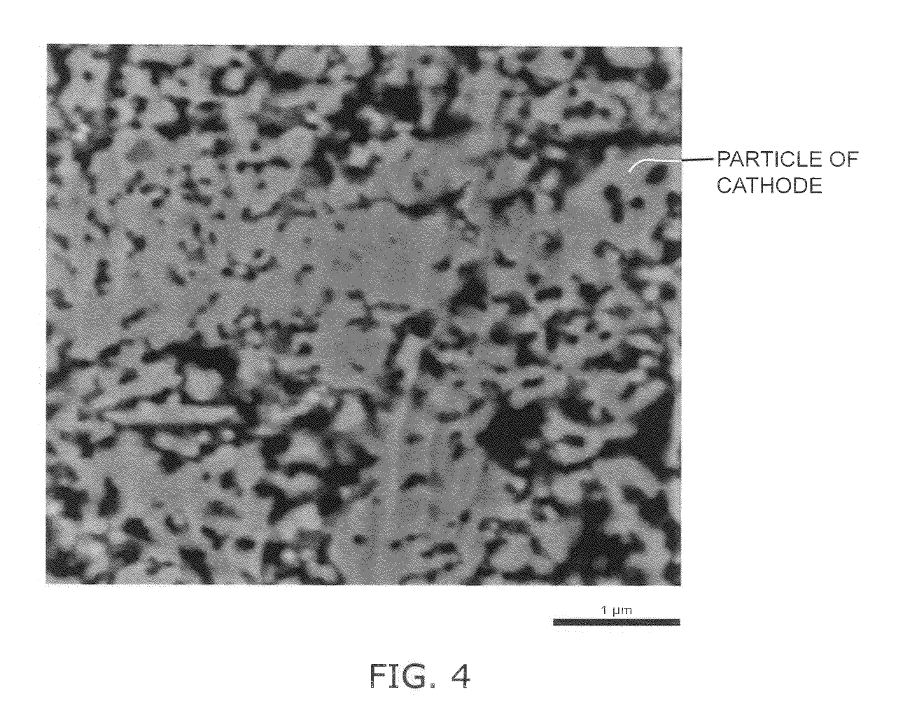

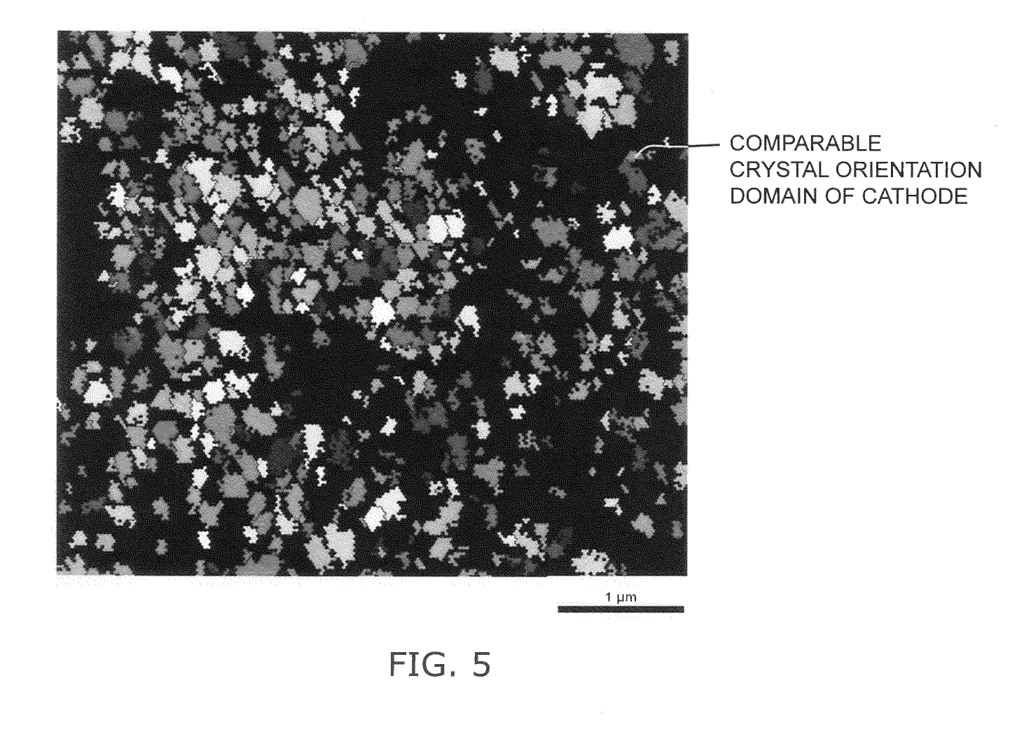

The results of the analysis of the crystal orientation of the cathode material will be described making reference to the drawings. FIG. 4 illustrates an example of a SEM image of a cross section of the cathode 50 that has been enlarged with a magnification of ×15000 by use of SEM. FIG. 5 illustrates an example of an EBSD image illustrating the results of analysis of crystal orientation by use of EBSD in relation to the cross section of the cathode 50 illustrated in FIG. 4.

As illustrated in FIG. 4, the mutually bonded plurality of constituent particles is visible by reference to the SEM image of the cathode 50. The SEM image can be used to calculate the total surface area of the solid phase in a cross section of the cathode 50. In the present embodiment, the term “solid phase of the cathode 50” is a general reference to the phase of the cathode 50 that is in a solid configuration, and refers to the concept of not including pores. In FIG. 4, the region corresponding to pores is shown in black. The range of calculating the total surface area of the solid phase may be the imaging range of the SEM. However, there is no limitation in this regard and, for example, the range may be configured as 5 micrometers×5 micrometers to 50 micrometers×50 micrometers.

As illustrated in FIG. 5, the outer shape of each comparable crystal orientation domain that is defined by boundaries in which the crystal orientation difference is at least 5 degrees is visible by reference to the EBSD image of the cathode material. The EBSD image can be used to calculate the total surface area of the comparable crystal orientation domains in a cross section of the cathode 50. The range of calculating the total surface area of the comparable crystal orientation domains may be the same as the range for calculation of the total surface area of the solid phase. The occupied surface area ratio of the total surface area of the comparable crystal orientation domains relative to the solid phase total surface area is at least 15%.

In this context, FIG. 5 does not include illustration of comparable crystal orientation domains in which the equivalent circle diameter is 0.03 micrometers or less. Therefore, in the present embodiment, the surface area of comparable crystal orientation domains in which the equivalent circle diameter is 0.03 micrometers or less is not included in the total surface area of the comparable crystal orientation domain. The exclusion of those comparable crystal orientation domains that are associated with an extremely small equivalent circle diameter is due to that fact that those comparable crystal orientation domains do not participate in the enhancement of the activity of the cathode. In the present embodiment, the term “equivalent circle diameter” denotes the diameter of a circle that has the same surface area as the target object.

The comparable crystal orientation domain and the particles denote different concepts in relation to the cathode 50.

The equivalent circle diameter of the comparable crystal orientation domains may be configured as 0.01 micrometers to 5 micrometers. The average equivalent circle diameter of the comparable crystal orientation domains may be configured as at least 0.03 micrometers to no more than 3.3 micrometers. The standard deviation of the equivalent circle diameter of the comparable crystal orientation domains may be at least 0.1 and no more than 3.3.

The standard deviation or the average equivalent circle diameter of the comparable crystal orientation domains in the cathode 50 may be controlled by adjusting the firing conditions for the cathode 50.

### Method of Manufacturing Cathode Material

Next, an example will be described of a method of manufacturing the cathode material.

The cathode material is obtained by preparation of a complex oxide that has a perovskite structure by use of a solid phase method, a liquid phase method (citrate process, Pechini method, co-precipitation method) or the like.

A “solid phase method” refers to a method in which a mixture obtained by blending a starting material including constituent elements in a predetermined ratio is fired, and then milled to obtain the target material.

A “liquid phase method” is a method for obtaining a target material that includes the sequential steps of (i) dissolving a starting material including constituent elements into a solution, (ii) obtaining a precursor of the target material from the solution by precipitation or the like, and then (iii) drying, firing and milling.

During the above processing steps, the average equivalent circle diameter or the occupied surface area ratio of the comparable crystal orientation domains in the cross section of the cathode material can be controlled by controlling the synthesis conditions (mixing method, rate of temperature increase, synthesis temperature/time) of the cathode material. More specifically, when the synthesis temperature is increased and the synthesis time is increased, the average equivalent circle diameter and the occupied surface area ratio of the comparable crystal orientation domains are increased. Conversely, when the synthesis temperature is decreased and the synthesis time is decreased, the average equivalent circle diameter and the occupied surface area ratio of the comparable crystal orientation domains are decreased.

The standard deviation of the equivalent circle diameter of the comparable crystal orientation domains in the cathode material can be controlled by controlling the milling/synthesis conditions of the starting materials. More specifically, when the milling conditions are weakened (decrease in the applied mechanical energy, and decrease in the mixing time), the standard deviation increases, whereas when the milling conditions are strengthened (increase in the applied mechanical energy, and increase in the mixing time), the standard deviation decreases.

### Method of Manufacturing Solid Oxide Fuel Cell 10

Next, an example of a method of manufacturing a solid oxide fuel cell 10 will be described.

Firstly, a green body of the anode current collecting layer 21 is formed by molding the anode current collecting layer powder by use of a die press molding method.

Next, a slurry is prepared by adding polyvinyl alcohol (PVA) as a binder to a mixture of a pore forming agent (for example, PMMA) and the powder for the anode active layer. Then, the green body for the anode active layer 22 is formed by printing the slurry using a printing method or the like onto the green body for the anode collecting layer 21.

Next, a slurry is prepared by mixing water and a binder with the solid electrolyte layer powder. Then, the green body for the solid electrolyte layer 30 is formed by coating the slurry using a coating method or the like onto the green body for the anode active layer 22.

Next, a slurry is prepared by mixing water and a binder with the barrier layer powder. Then, the green body for the barrier layer 40 is formed by coating the slurry using a coating method or the like onto the green body for the solid electrolyte layer 30.

The stacked body of the green bodies prepared is cofired for 2 to 20 hours at 1300 to 1600 degrees C. to form a cofired body configured by the anode 20, the solid electrolyte layer 30 and the barrier layer 40.

Next a slurry is prepared by mixing water and a binder with the cathode active layer powder (for example, LSCF, LSF, LSC, and LSM-8YSZ, or the like). Then, a green body for the cathode 50 is formed by coating the slurry using a coating method or the like onto the barrier layer 40.

Next, the green body for the cathode 50 is fired (firing temperature 1000 degrees C. to 1200 degrees C., firing time 1 to 10 hours). At this time, the average equivalent circle diameter or the occupied surface area ratio of the comparable crystal orientation domains in the cross section of the cathode 50 can be controlled by controlling the synthesis conditions. More specifically, when the firing temperature is increased and the firing time is increased, the average equivalent circle diameter and the occupied surface area ratio of the comparable crystal orientation domains are increased. Conversely, when the firing temperature is decreased and the firing time is decreased, the average equivalent circle diameter and the occupied surface area ratio of the comparable crystal orientation domains are decreased. The standard deviation of the equivalent circle diameter of the comparable crystal orientation domains in the cathode 50 can be controlled by controlling the powder filling density of the cathode green body. More specifically, when the powder filling density of the cathode green body is reduced, the standard deviation increases, whereas when the powder filling density of the cathode green body is increased, the standard deviation decreases.

### Other Embodiments

The present invention is not limited to the above embodiments, and various changes or modifications may be added within a scope that does not depart from the scope of the invention.

(A) In the above embodiment, although the solid oxide fuel cell 10 includes the anode 20, the solid electrolyte layer 30, the barrier layer 40 and the cathode 50, there is no limitation in this regard. For example, the solid oxide fuel cell 10 may omit inclusion of the barrier layer 40. Furthermore, the solid oxide fuel cell 10 may be separately provided with a dense or porous barrier layer between the solid electrolyte layer 30 and the barrier layer 40.
(B) In the above embodiment, although an SEM was used for observation of the cross section of the cathode material and the cathode 50, there is no limitation in this regard. When observing the particles, use is also possible of various types of electron microscopes such as a field emission scanning electron microscope (FE-SEM), a scanning transmission electronic microscope (STEM), and a transmission electron microscope (TEM), or the like.

### Examples

Although the examples of a cell according to the present invention will be described below, the present invention is not limited to the following examples.

### Preparation of Samples No. 1 to No. 20

Firstly, a NiO and 8YSZ mixed powder was molded using a die pressure molding method to form a green body for the anode current collecting layer.

Then, a slurry was formed by adding PVA to a mixture of NiO, 8YSZ, and PMMA. Next, the slurry was printed onto the green body of the anode current collecting layer using a printing method to thereby form a green body for the anode active layer.

Next, a mixture of 8YSZ, water and a binder were mixed to prepare a slurry. Then the slurry was coated on the green body for the anode active layer to form a green body for the solid electrolyte layer.

Then, a mixture of GDC, water and a binder were mixed to prepare a slurry. The slurry was coated on the green body for the solid electrolyte layer to form a green body for the barrier layer.

Then the stacked body formed from the respective green bodies for the anode, the solid electrolyte layer and the barrier layer was cofired (5 hours at 1400 degrees C.) to prepare a co-fired body formed from the anode, the solid electrolyte layer and the barrier layer.

Thereafter, a slurry was prepared by preparing the cathode materials described in Table 1, and mixing the cathode materials according to Samples No. 1 to No. 20 with water and a binder. The slurry was coated onto the barrier layer to form a green body for the cathode.

Then, the green body for the cathode was fired for three hours at 1050 degrees C. to prepare the cathode.

### Analysis of Crystal Orientation of Cathode Material

An analysis image using an EBSD method was obtained by using an EBSD device (OIM manufactured by TSL) to measure a cross section of a block which is produced by the cathode material according to Samples No. 1 to No. 20 solidifying with resin. In the EBSD image, those comparable crystal orientation domains were imaged in which the outer edge is defined by boundaries in which the crystal orientation difference is at least 5 degrees (reference is made to FIG. 3).

The occupied surface area ratio of the comparable crystal orientation domains relative to the total solid phase of the cathode material was calculated with reference to the cross section of the cathode material for each sample. The calculation results are summarized in Table 1.

### Analysis of Crystal Orientation of Cathode

An analysis image using an EBSD method was obtained by using an EBSD device (OIM manufactured by TSL) to measure a cross section of the cathode according to Samples No. 1 to No. 20. In the EBSD image, those comparable crystal orientation domains were imaged in which the outer edge is defined by boundaries in which the crystal orientation difference is at least 5 degrees (reference is made to FIG. 5).

The occupied surface area ratio of the comparable crystal orientation domains relative to the total solid phase of the cathode was calculated with reference to the cross section of the cathode for each sample. The calculation results are summarized in Table 1.

### Measurement of Output Density

Nitrogen gas was supplied to the anode and air to the cathode in relation to each sample, and the temperature was increased to 750 degrees C. When the temperature reached 750 degrees C., hydrogen gas was supplied to the anode and a reduction process was performed for 3 hours.

Thereafter, the output density at a current density: 0.2 A/cm² and a measurement temperature: 750 degrees C. was measured for Samples No. 1 to No. 20. The measurement results were summarized in Table 1. In Table 1, those samples that exhibit an output density of no more than 0.15 W/cm² are evaluated as X, and those samples that exhibit an output density of more than 0.15 W/cm² are evaluated as O.

TABLE 1

| | Cathode Material | | Cathode | | |
|---|---|---|---|---|---|
| | | Occupied surface area ratio of | Occupied surface area ratio of | | |
| Sample | | comparable crystal orientation | comparable crystal orientation | Output Density | |
| No. | Type | domains (%) | domains (%) | (W/cm²) | Evaluation |
| 1 | LSCF | 2 | 4 | 0.11 | x |
| 2 | LSCF | 5 | 8 | 0.12 | x |
| 3 | LSCF | 10 | 15 | 0.33 | ∘ |
| 4 | LSCF | 14 | 24 | 0.30 | ∘ |
| 5 | LSCF | 27 | 38 | 0.28 | ∘ |
| 6 | LSCF | 39 | 56 | 0.33 | ∘ |
| 7 | LSCF | 48 | 67 | 0.29 | ∘ |
| 8 | LSCF | 62 | 75 | 0.31 | ∘ |
| 9 | LSCF | 69 | 83 | 0.33 | ∘ |
| 10 | LSF | 3 | 4 | 0.10 | x |
| 11 | LSF | 15 | 24 | 0.25 | ∘ |
| 12 | LSF | 28 | 44 | 0.28 | ∘ |
| 13 | LSF | 36 | 52 | 0.26 | ∘ |
| 14 | LSF | 52 | 69 | 0.29 | ∘ |
| 15 | LSF | 60 | 77 | 0.28 | ∘ |
| 16 | SSC | 6 | 10 | 0.15 | x |
| 17 | SSC | 16 | 22 | 0.30 | ∘ |
| 18 | SSC | 25 | 36 | 0.33 | ∘ |
| 19 | SSC | 42 | 62 | 0.32 | ∘ |
| 20 | SSC | 48 | 75 | 0.35 | ∘ |

As illustrated in Table 1, it is confirmed that the output density was enhanced when the occupied surface area ratio of the comparable crystal orientation domains in the cross section of the cathode material was at least 10%.

Furthermore, as illustrated in Table 1, it is confirmed that the output density was enhanced when the occupied surface area ratio of the comparable crystal orientation domains in the cross section of the cathode was at least 15%.

1. A cathode material comprising:
a main component being a complex oxide having a perovskite structure expressed by a general formula ABO₃, the perovskite structure including at least one of La and Sr at the A site, wherein
a occupied surface area ratio of a plurality of comparable crystal orientation domains to a total solid phase is at least 10%, the plurality of comparable crystal orientation domains is defined by boundaries exhibiting a crystal orientation difference of at least 5 degrees in a crystal orientation analysis of a cross section by a method of electron backscatter diffraction.

2. A solid oxide fuel cell comprising
an anode,
a cathode including a main component being a complex oxide having a perovskite structure expressed by a general formula ABO₃, the perovskite structure including at least one of La and Sr at the A site,
a solid electrolyte layer disposed between the anode and the cathode,
a occupied surface area ratio of a plurality of comparable crystal orientation domains to a total solid phase being at least 10%, the plurality of comparable crystal orientation domains defined by boundaries exhibiting a crystal orientation difference of at least 15 degrees in a crystal orientation analysis of a cross section of the cathode by a method of electron backscatter diffraction.
